(19) United States
(12) Patent Application Publication
(10) Pub. No.: US 2024/0377808 A1
(43) Pub. Date: Nov. 14, 2024

(54) SYSTEMS AND METHODS FOR AUTONOMOUS ANOMALY MANAGEMENT OF AN INDUSTRIAL SITE

(71) Applicant: Schneider Electric Systems USA, Inc., Foxboro, MA (US)

(72) Inventors: Vladislav Korablev, Foxboro, MA (US); Mark Green, Worthing (GB); Vijay Vallala, Foxboro, MA (US); Subha Mahanti, Foxboro, MA (US)

(73) Assignee: Schneider Electric Systems USA, Inc., Foxboro, MA (US)

(21) Appl. No.: 18/658,549

(22) Filed: May 8, 2024

Related U.S. Application Data
(60) Provisional application No. 63/464,726, filed on May 8, 2023.

(51) Int. Cl. G05B 19/4069; G05D 1/60; G05D 101/15; G05D 105/80; G05D 107/70

(52) U.S. Cl. CPC G05B 19/4069; G05D 1/60; G05D 2101/15; G05D 2105/89; G05D 2107/70

(57) ABSTRACT

A method is provided for autonomous anomaly management of an industrial site having industrial equipment in its field, including identifying industrial equipment to be inspected in the field, obtaining select autonomous sensor data about the identified industrial equipment from at least one mobile autonomous device routed along respective routes for accessing the identified industrial equipment, processing the autonomous sensor data to identify a potential anomaly, and in response to identifying a potential anomaly, taking action(s) to address the potential anomaly, wherein, as a combination, identifying the equipment, processing the autonomous sensor data, identifying the potential anomaly, and determining the action(s) use historical measurement and/or control data from the industrial equipment, historical autonomous sensor data, extrinsic data including at least one of guidance and/or constraint data about the industrial site, and supervisory and/or control data generated and/or collected by supervisory control of the industrial site disposed remote from the field.

### CROSS REFERENCE TO RELATED APPLICATIONS

This application claims priority to U.S. Provisional Patent Application Ser. No. 63/464,726 filed May 8, 2023, which is incorporated herein by reference in its entirety.

### TECHNICAL FIELD

This disclosure relates generally to management systems, and more particularly, to systems and methods to enable and improve autonomous industrial site operation and maintenance.

### BACKGROUND

As is known, an industrial operation, which may include one or more industrial sites (e.g., plants, drilling rigs, water treatment facilities) etc., at one or more locations, typically includes a plurality of industrial equipment. Industrial equipment used at the industrial site(s) can come in a variety of forms and may be associated with various processes, for example, depending on the industrial operation. For example, industrial process control and monitoring measurement devices are typically utilized to measure process measurements such as pressure, flow, level, temperature and analytical values in numerous industrial applications and market segments. Applications of the industrial sites and segments thereof may include, for example, oil & gas, energy, food & beverage, water & wastewater, chemical, petrochemical, pharmaceutical, metals, and mining and minerals. The industrial equipment and/or processes are typically operated and/or managed by one or more system operators. Additionally, tasks, such as the inspection and/or repair of the industrial equipment and/or processes, are usually manually performed.

As is known, the use of autonomous devices in industrial sites can improve efficient operation of an industrial site. As is also known, there is a constant need to improve operating efficiency of both traditional and autonomous aspects of industrial sites. For example, a goal for future autonomous devices in industrial sites is to handle process equipment failures and repairs without a human in the loop (or with very little human interactions).

Industrial sites can generate large amounts of information. Effective use of autonomous devices for autonomous operation of an industrial site can be limited when this information is inadequately managed and leveraged.

Conventional methods and systems for using autonomous devices in an industrial site have generally been considered satisfactory for their intended purpose. However, there is still a need in the art for managing and leveraging the large amount of data available to an industrial site for using autonomous devices in the operation and maintenance of the industrial site.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings. To achieve these and other advantages and in accordance with the purpose of the illustrated embodiments, in one aspect, disclosed is a method of autonomous anomaly management of an industrial site having industrial equipment in the field of the industrial site. The method includes identifying industrial equipment to be inspected in the field of the industrial site, obtaining select autonomous sensor data about the identified industrial equipment from at least one mobile autonomous device routed along respective routes for accessing the identified industrial equipment, processing the autonomous sensor data to identify a potential anomaly, and in response to identifying a potential anomaly, taking at least one action to address the potential anomaly, wherein, as a combination, identifying the equipment, processing the autonomous sensor data, identifying the potential anomaly, and determining the at least one action use historical measurement and/or control data from the industrial equipment, historical autonomous sensor data, extrinsic data including enterprise data, customer relationship management data, guidance data, optimization data, and/or constraint data about the industrial site, and supervisory and/or control data generated and/or collected by supervisory control of the industrial site disposed remote from the field.

In accordance with a further aspect of the disclosure, a system for performing autonomous inspections of equipment and/or processes in an industrial plant, is provided that includes a memory configured to store a plurality of programmable instructions and a processing device in communication with the memory, wherein the processing device, upon execution of the plurality of programmable instructions is configured to identify industrial equipment to be inspected in the field of the industrial site, obtain select autonomous sensor data about the identified industrial equipment from at least one mobile autonomous device routed along respective routes for accessing the identified industrial equipment, process the autonomous sensor data to identify a potential anomaly, and in response to identifying a potential anomaly, take at least one action to address the potential anomaly. As a combination, identifying the equipment, processing the autonomous sensor data, identifying the potential anomaly, and determining the at least one action use historical measurement and/or control data from the industrial equipment, historical autonomous sensor data, extrinsic data including enterprise data, customer relationship management data, guidance data, optimization data and/or constraint data about the industrial site, and supervisory and/or control data generated and/or collected by supervisory control of the industrial site disposed remote from the field.

In accordance with a further aspect of the disclosure, a method is provided for autonomous anomaly management of an industrial site having industrial equipment in the field of the industrial site. The method includes identifying industrial equipment to be inspected in the field of the industrial site, obtaining select autonomous sensor data about the identified industrial equipment from at least one mobile autonomous device routed along respective routes for accessing the identified industrial equipment, processing the autonomous sensor data to identify a potential anomaly, in response to identifying a potential anomaly, recommending at least one action to address the potential anomaly, training using machine learning at least one of the identifying the equipment, processing the autonomous sensor data, identifying the potential anomaly, and determining the at least one action, setting a confidence level in the recommended action, the confidence level being a function of an amount of the training performed, and in response to the confidence level being below a threshold, controlling the respective routes of the one or more autonomous mobile device to obtain additional autonomous sensor data related to the anomaly. Processing the additional autonomous sensor data increases the confidence level.

### BRIEF DESCRIPTION OF THE DRAWINGS

The foregoing features of the disclosure, as well as the disclosure itself may be more fully understood from the following detailed description of the drawings, in which:

FIG. 1 shows an example industrial operation, in accordance with embodiments of the disclosure;

FIG. 2 shows a system diagram of an autonomous industrial system, in accordance with embodiments of the disclosure;

FIG. 2A shows a schematic diagram of a data store of the autonomous industrial system, in accordance with embodiments of the disclosure;

FIG. 3 shows a flow diagram of an example method of processing autonomous sensor data and outputting action recommendations, in accordance with embodiments of the disclosure;

FIG. 4 shows a flow diagram of an example method of training an autonomous site model using simulation data, in accordance with embodiments of the disclosure;

FIG. 5 shows a block diagram of an example data pipeline of the data store shown of the autonomous industrial system, in accordance with embodiments of the disclosure;

FIG. 6 shows a flowchart of an example method of autonomous anomaly management in an industrial site, in accordance with embodiments of the disclosure; and

FIG. 7 shows a block diagram of an exemplary computer system that could be used to implement portions of the autonomous industrial system shown in FIG. 2, in accordance with embodiments of the disclosure.

Identical reference numerals have been used, where possible, to designate identical elements that are common to the figures. However, elements disclosed in one embodiment may be beneficially utilized on other embodiments without specific recitation.

### DETAILED DESCRIPTION

Disclosed herein are systems and methods for enabling and improving autonomous industrial site operation and management. Autonomous mobile devices using the techniques disclosed herein, for example, can improve the operating efficiency by eliminating dull, distant, dangerous and dirty jobs, freeing up skilled workers to focus on other tasks. By integrating information from autonomous mobile devices with other information available to the industrial site, efficiency, reliability and safe autonomous operation of the industrial site can be increased. 5G as an enabling technology provides features that can be used to integrate information used by autonomous industrial sites. The techniques disclosed herein may enable autonomous mobile devices in an industrial site to attain a higher capacity, interact information from more autonomous mobile devices, increase routing accuracy of the autonomous mobile devices, and improve resiliency of autonomous operation of the industrial site in various environments.

Example use cases for autonomous operation of the industrial site may include, for example and without limitation, using measurements from analogue gauges (that may be unconnected to a control system of the industrial site), using positions of levers (that may be unconnected to a control system of the industrial site), using measurements associated with alarms, advising systems and/or operators of degraded (e.g., deteriorating) equipment, and adapting control parameters of industrial equipment used by the industrial site to extend operating life and/or increase sustainability. Another use case includes the autonomous device being navigated to an inspection point in response to an alarm and/or a condition identified by a diagnostic analysis (e.g., an AI based diagnostic analysis based on AI training). The autonomous device can then capture autonomous sensor data from the inspection point and provide the captured autonomous sensor data for diagnostic analysis. The diagnostic analysis can be used to analyze the autonomous sensor data, identify a problem that caused the alarm or identified condition and recommend or control maintenance actions to correct the problem. The maintenance action can be, for example, adjustment, replacement, repair, or bypass of (e.g., to work around) a component of the industrial equipment at the industrial site. The maintenance action can be performed automatically, by a human operator, or automatically once approved by a human operator.

The autonomous mobile devices can be controlled and/or trained to perform autonomous inspections of equipment and/or processes in an industrial site. The inspections may correspond to or include routine and/or hazardous inspections, for example.

The disclosed systems and/or methods can perform autonomous inspections of industrial equipment, including industrial processes that can use a combination of industrial equipment, which can include identifying industrial equipment to be inspected in the industrial site, and capturing select autonomous sensor data about the identified equipment using at least one autonomous device. The autonomous device can be a mobile device that can be routed along respective routes for accessing the identified industrial equipment. The autonomous sensor data can be processed (e.g., on one or more autonomous devices, on an edge device provided in the field that has access to field devices and a private or public network, supervisory and/or control devices remote from the field, and/or on a cloud. The autonomous sensor data can be processed to identify potential anomalies, which can include areas for improvement (e.g., at least one safety-related issue, hazard, maintenance related issue, etc.). In response to identifying potential anomalies, at least one action may be taken or performed to address the identified potential anomalies.

As a combination, identifying the equipment, processing the autonomous sensor data, identifying the potential anomaly, and determining the at least one action use historical measurement and/or control data from the industrial equipment in the field, historical autonomous sensor data, extrinsic data including at least one of guidance and/or constraint data about the industrial site, and supervisory data generated and/or collected by supervisory control of the industrial site disposed remote from the field. In other words, each of listed types of data (meaning the historical measurement and/or control data from the industrial equipment in the field, the historical autonomous sensor data, the extrinsic data, and the supervisory or control data) are used. The listed types of data can also include live sensor data captured by the industrial equipment in the field in real time. The listed types of data can also or alternatively include autonomous sensor data captured by the mobile autonomous device in real time. In addition, each of the listed steps (e.g., of identifying the equipment, processing the autonomous sensor data, identifying the potential anomaly, and determining the at least one action} uses at least one of the types of data listed.

In accordance with some embodiments of this disclosure, the at least one autonomous device or a process that controls the at least one autonomous device is trained using machine learning techniques and/or using information collected during an inspection traditionally performed by a human. For example, the at least one autonomous device can be trained to identify the industrial equipment to be inspected identify the select autonomous sensor data to be captured, process the autonomous sensor data to identify the potential anomalies, and/or take the at least one action.

The at least one autonomous device can be trained using reinforcement learning techniques, supervised learning techniques, and/or unsupervised learning techniques. Artificial intelligence-based techniques can be used to identify the potential anomalies.

The at least one action that may be taken (which can include performing the action) to address the identified potential anomaly may include recommending actions to address the identified anomaly and/or performance of at least one maintenance and/or process action in the industrial site or at a control system that controls the industrial site. The recommended solutions may be provided in a notification of a work order, for example. In accordance with some embodiments of this disclosure, the provided notification may take the form of a visual and/or an audible communication. The notification may be provided on or using one or more interfaces, for example. For example, the one or more interfaces may include an operator screen and a visual and audible alarm.

The recommendation for a maintenance action can be, for example, a warning, a work order or recommendation to replace or repair a particular part. The recommendation for a process action can be, for example, an adjustment signal or recommendation to adjust a particular control parameter (meaning a parameter (e.g., a process set point) of a process in the field or a parameter for controlling a process in the field by a supervisory control that is remote from the field). The adjustment of the control parameter can either modify a process, disable a process, or cause a process to be bypassed, thus working around an identified problem, etc. The adjustment signal can be provided with a notification that allows an operator to manage the adjustment signal, such as to approve, disapprove, delay, or change the adjustment signal.

It is understood that the above-discussed at least one autonomous device may take a variety of forms. For example, the at least one autonomous device may correspond to or include a drone or robot, and be configured to navigate the industrial site. The at least one autonomous device may include various input devices and sensors, for example, for identifying the industrial equipment to be inspected and for capturing the select autonomous data. The input devices and sensors may include, for example, at least one microphone, at least one image capture device, at least one thermal sensor, at least one pressure sensor, at least one motion sensor, one or more sensors that detect level, flow, pH level, speed, motion, position, gas, at least one light detection and ranging (LIDAR) sensor, at least one thermal camera, at least one range finding camera, at least one optical camera, at least one audio sensor (e.g., to detect noise, vibration, and/or friction). It is understood that the at least one autonomous device may include various other features and functionalities. As one example, the at least one autonomous device may be equipped with at least one light source for enabling capturing of the select information in low light conditions.

It is understood that the term “input” as used herein may refer to data that a processor receives, and the term “output” may refer to data that a processor sends. Inputs and outputs may be digital, analog and/or mixed (i.e., digital and analog). Receiving and sending data can be via push or pull operations. A processor may convert/reconvert digital and analog input signals to a digital representation for internal processing. A processor may also convert/reconvert internally processed digital signals to digital and/or analog output signals to provide some indication, action, or other response (such as an input for another processor). Digital inputs may be used, for example, to determine the operational status/position of equipment (e.g., is a breaker open or closed, etc.) or read an input synchronous signal from a utility pulsed output. Additionally, analog outputs may be used, for example, to provide variable control of valves, motors, heaters, or other loads/processes in industrial systems. Further, analog inputs may be used, for example, to gather variable operational data and/or in proportional control schemes.

It is understood that data received, captured and/or generated using the techniques disclosed herein may include input/output (I/O) data. It is understood that the I/O data may take the form of digital I/O data, analog I/O data, or a combination digital and analog I/O data. The I/O data may convey status information, for example, and many other types of information, as will be apparent to one of ordinary skill in the art from discussions above and below. It is understood that the terms “processor” and “controller” are sometimes used interchangeably herein. For example, a processor may be used to describe a controller. Additionally, a controller may be used to describe a processor.

Among the many features, advantages and aspects of the disclosure include an ability to reduce danger for operators, reduce or eliminate the need for operators to perform routine or hazardous inspections, digitize analog equipment, and provide a step towards fully autonomous operations of an industrial site (e.g., using Artificial Intelligence (AI) to operate the entire industrial site). Additional features, advantages and aspects will be appreciated from the discussions below.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth. It is to be appreciated the embodiments of this disclosure as discussed below are implemented using a software algorithm, program, or code that can reside on a computer useable medium for enabling execution on a machine having a computer processor. The machine can include memory storage configured to provide output from execution of the computer algorithm or program.

As used herein, the term “software” is meant to be synonymous with any logic, code, or program that can be executed by a processor of a host computer, regardless of whether the implementation is in hardware, firmware or as a software computer product available on a disc, a memory storage device, or for download from a remote machine. The embodiments described herein include such software to implement the equations, relationships, and algorithms described above. One skilled in the art will appreciate further features and advantages of the disclosure based on the above-described embodiments. Accordingly, the disclosure is not to be limited by what has been particularly shown and described, except as indicated by the appended claims.

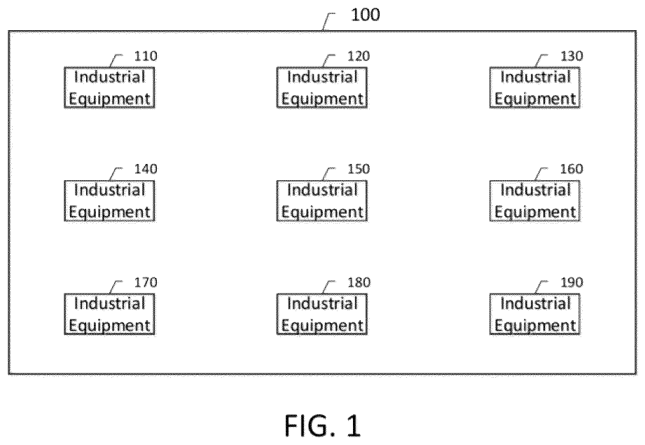

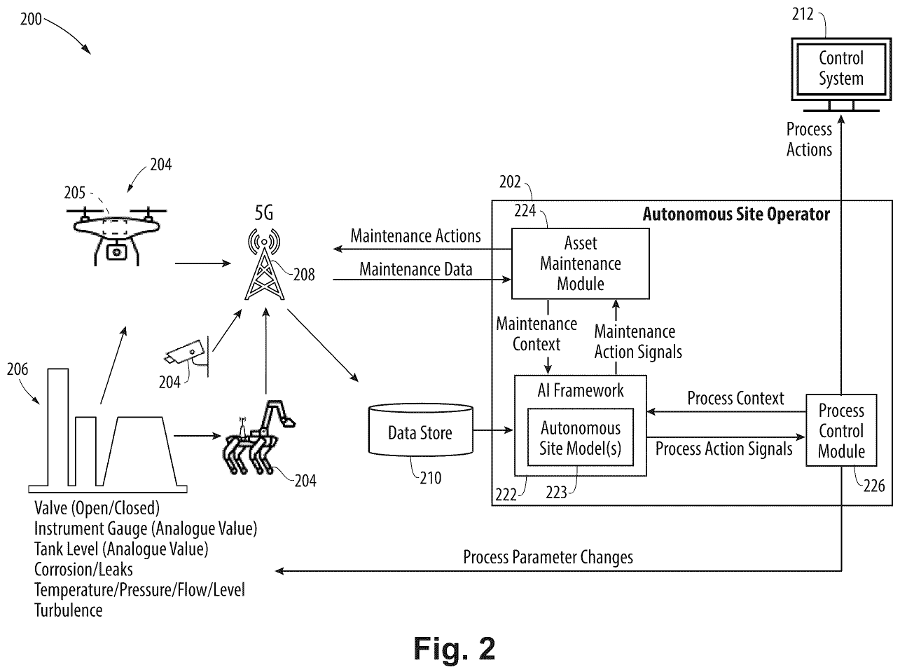

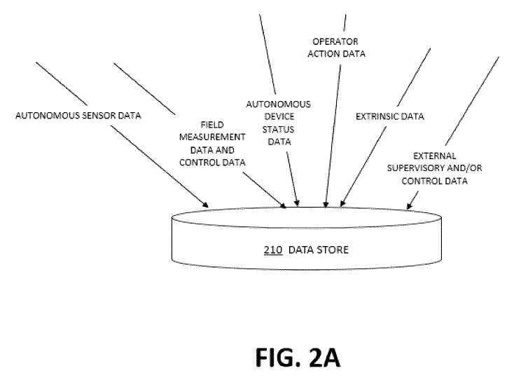

Reference will now be made to the drawings wherein like reference numerals identify similar structural features or aspects of the subject disclosure. For purposes of explanation and illustration, and not limitation, a block diagram of an exemplary embodiment of an industrial operation in accordance with the disclosure is shown in FIG. 1 and is designated generally by reference character 100. Other embodiments of the industrial operation 100 in accordance with the disclosure, or aspects thereof, are provided in FIGS. 2-7, as will be described.

Referring to FIG. 1, an example industrial operation 100 in accordance with embodiments of the disclosure includes a plurality of industrial equipment 110, 120, 130, 140, 150, 160, 170, 180, 190. The industrial equipment (or devices) 110, 120, 130, 140, 150, 160, 170, 180, 190 may be associated with a particular application (e.g., an industrial application), applications, and/or process(es). The industrial equipment 110, 120, 130, 140, 150, 160, 170, 180, 190 may include electrical or electronic equipment, for example, such as machinery associated with the industrial operation 100 (e.g., a manufacturing or natural resource extraction operation). The industrial equipment 110, 120, 130, 140, 150, 160, 170, 180, 190 may also include the controls and/or ancillary equipment associated with the industrial operation 100, for example, process control and monitoring measurement devices. In embodiments, the industrial equipment 110, 120, 130, 140, 150, 160, 170, 180, 190 may be installed or located in one or more facilities (i.e., buildings) or other physical locations associated with the industrial operation 100. The facilities may correspond, for example, to industrial buildings or plants. Additionally, the physical locations may correspond, for example, to geographical areas or locations.

The industrial equipment 110, 120, 130, 140, 150, 160, 170, 180, 190 may each be configured to perform one or more tasks in some embodiments. For example, at least one of the industrial equipment 110, 120, 130, 140, 150, 160, 170, 180, 190 may be configured to produce or process one or more products, or a portion of a product, associated with the industrial operation 100. Additionally, at least one of the industrial equipment 110, 120, 130, 140, 150, 160, 170, 180, 190 may be configured to sense or monitor one or more parameters (e.g., industrial parameters) associated with the industrial operation 100. For example, industrial equipment 110 may include or be coupled to a temperature sensor configured to sense temperature(s) associated with the industrial equipment 110, for example, ambient temperature proximate to the industrial equipment 110, temperature of a process associated with the industrial equipment 110, temperature of a product produced by the industrial equipment 110, etc. The industrial equipment 110 may additionally or alternatively include one or more pressure sensors, flow sensors, level sensors, vibration sensors and/or any number of other sensors, for example, associated the application(s) or process(es) associated with the industrial equipment 110. The application(s) or process(es) may involve water, air, gas, electricity, steam, oil, etc. in one example embodiment.

The industrial equipment 110, 120, 130, 140, 150, 160, 170, 180, 190 may take various forms and may each have an associated complexity (or set of functional capabilities and/or features). For example, industrial equipment 110 may correspond to a “basic” industrial equipment, industrial equipment 120 may correspond to an “intermediate” industrial equipment, and industrial equipment 130 may correspond to an “advanced” industrial equipment. In such embodiments, intermediate industrial equipment 120 may have more functionality (e.g., measurement features and/or capabilities) than basic industrial equipment 110, and advanced industrial equipment 130 may have more functionality and/or features than intermediate industrial equipment 120. For example, in embodiments industrial equipment 110 (e.g., industrial equipment with basic capabilities and/or features) may be capable of monitoring one or more first characteristics of an industrial process, and industrial equipment 130 (e.g., industrial equipment with advanced capabilities) may be capable of monitoring one or more second characteristics of the industrial process, with the second characteristics including the first characteristics and one or more additional parameters. It is understood that this example is for illustrative purposes only, and likewise in some embodiments the industrial equipment 110, 120, 130, etc. may each have independent functionality.

Although industrial equipment (e.g., 110, 120, 130, etc.) may be operated by, or at least monitored by, one or more system operators, a system and method for monitoring, operating, adjusting, enabling and/or improving operation and/or maintenance etc. of an industrial site and its industrial equipment (e.g., 110, 120, 130, etc.) is disclosed.

With reference to FIG. 2, an autonomous industrial system 200 is shown. An autonomous site operator 202 is shown that communicates with one or more mobile autonomous devices 204 that can navigate or move with respect to industrial equipment 206 in the field of the autonomous industrial site 200. The mobile autonomous devices 204 sense properties associated with industrial equipment 206 and output corresponding autonomous sensor data that can be communicated to autonomous site operator 202, e.g., via wired or wireless communication. In the example shown, wireless communication is used for communication between the autonomous devices 204 and autonomous site operator 202, such as by using a 5G network 208. 5G network 208 can provide increased bandwidth relative to earlier generations of wireless communication networks, which enables a large amount of autonomous sensor data to be shared by autonomous devices 204. Autonomous site operator 202 can communicate with autonomous devices 204 that belong to different fleets, were commissioned at different times, and/or are manufactured or distributed by different vendors.

In this way, autonomous sensor data from disparate autonomous devices 204 from one or more fleets can be used by AI framework 222 to make inferences and operations decisions, including process actions and maintenance actions. Data store 210 can store dynamic autonomous device status data about current location, readiness (e.g., battery charge level to achieve the task at hand), availability, and capabilities about the fleets and/or individual autonomous devices 204. This allows AI framework 222 to make decisions about which autonomous device 204 to select for deployment, including for decisions about substituting one autonomous device 204 for another, e.g., when battery is low or a malfunction occurs.

The autonomous sensor data 208 can be stored in data store 210. Additionally, measurement data obtained from sensors included in the field with industrial equipment 206 and/or field control data provided to or from programmable logic devices (PLCs) or the like (e.g., microprocessors or microcontrollers) in the field for controlling industrial equipment 206 can be stored in data store 210. The autonomous sensor data 208, measurement data, and field control data can each include historical and/or current data.

Data received by store 210 is shown in greater detail in FIG. 2A. The data received includes autonomous sensor data sensed by sensors of autonomous devices 204, measurement data and control data obtained from industrial equipment in the field of industrial site 206, dynamic status data about the autonomous devices 204 and their fleets, operator action data obtained from actions performed by an operator (e.g., operating in a control room or other control system 212), external supervisor and/or control data from control systems 212 that are remote from the field of industrial site 206, and extrinsic data.

The extrinsic data can include, for example, enterprise data, customer relationship management data, guidance data, optimization data, and/or constraint data about industrial site 206 and its related business. Some examples of the extrinsic data include guidelines, specifications, configurations, operator data (e.g., a user profile of an operator performing control operations on industrial site 206), governance information pertaining to the industrial site (e.g., state, federal, corporate regulations), system diagnostics guidelines (e.g., an error code, textual description of an associated error, textual corrective action for correcting the error), configuration guidelines (e.g., a code for respective rules, a textual description of the rule, and a textual corrective action for correcting a misconfiguration that does not comply with the rule, symptom guidelines (e.g., a symptom code, textual description of an associated predicted fault and/or failure, textual corrective action for averting the predicted fault and/or failure), configuration guidelines for a process control system 212 for detecting misconfigurations associated with the configuration of the process control system 212, logs (running system logs, network monitoring logs, event logs, libraries of predefined symptoms of various conditions, design specifications.

Autonomous devices 204 can include autonomous land, airborne, or waterborne vehicles, such as robots or drones that can be navigated along a specified route in field. In one or more embodiments, the autonomous devices 204 can be fixed (permanently or temporarily) to a location in or proximate the field at one end of the autonomous device 204, and can move at another end of the autonomous device 204 (e.g., a mounted camera that can pivot about its fixed end for scanning industrial equipment 206).

Autonomous devices 204 can be positioned, and/or position their sensors to observe and/or measure a physical property, a condition, and/or read an analogue value. The measurement, observation, condition, or analogue value can be converted into a digital value that can be transmitted via wireless communication, to data store 210 and/or asset maintenance module 224. For example, an autonomous device 204 can observe whether a valve is opened or closed and transmit a corresponding binary value. In another example, the autonomous device 204 can image an instrument's analogue gauge (that may be unconnected to a control system of the industrial site), process the image to determine the analogue value displayed by the gauge, convert the analogue value to a digital value, and transmit the digital value. In a further example, the autonomous device 204 can image a tank, process the image to determine an analogue value that corresponds to the level of a substance stored in the tank (as indicated by an analogue gauge or other measurement device), convert the analogue value to a digital value, and transmit the digital value. In an additional example, the autonomous device 204 can image a tank, pipe, belt, etc., process the image to determine if there is degradation (e.g., deterioration, corrosion, a leak, crack, tear, other signs of wear and tear, improper function (e.g., causing turbulence or defects in a product)), assign a binary or digital value that represents the presence or degree of the degradation, and transmit the digital value. In still another example, the autonomous device 204 can measure physical properties such as temperature, pressure, flow velocity, radiation, presence of a particular chemical, motion, etc., represent the measured value as a digital value, and transmit the digital value. In yet another example, the autonomous device 204 can image a vessel holding a liquid, process the image to determine whether there is turbulence or a level of turbulence in the liquid, represent the presence or level of turbulence with a digital value, and transmit the digital value.

The gauge, lever, tank, pipe, etc. associated with the physical property, a condition, imaged or measured by the autonomous device 204 can be identified using a location of the autonomous device 204 (e.g., using GPS and/or other geolocation or position determination systems) and/or a value provided by a tag associated with gauge, lever, tank, pipe, etc. The tag can be an RFID tag, an optical code, or an alphanumeric tag that the autonomous device 204 can read using the appropriate techniques. The digital value can be displayed at a human machine interface (HMI) in a control room and/or can be used autonomous site operator 202 for diagnosing a condition (e.g., by a diagnostic engine trained using AI), taking maintenance actions and/or taking process actions in accordance with the disclosure. The diagnostic engine can further detect when changes in the industrial site have occurred that could be a sign of degradation.

Autonomous devices 204 can perform inspections on a routine basis and/or can perform other or additional inspections, such as to increase confidence in an inference when confidence in the inference (or an amount of training used to arrive at the inference) is below a threshold. The additional inspection can include navigating to a location to capture autonomous sensor data and/or gathering additional data while already positioned at a location.

Autonomous devices 204 can perform inspections that have previously been performed by human operators. Autonomous devices 204 can further perform inspections that would be hazardous or costly for human operators to perform.

A control system 212 that is remote from industrial equipment 206 can communicate with industrial equipment 206 for receiving information about or from industrial equipment 206 and controlling industrial equipment 206. Control system 212 can include one or more types of control systems, including, for example and without limitation, a control panel, control room that can be equipped with a HMI, a distributed control systems (DCS), a supervisory control and data acquisition (SCADA) system, programmable automation controllers (PACs), remote terminal units (RTUs), industrial automation and control systems (IACS), intelligent electronic devices (IEDs).

Autonomous site operator 202, including its components, include hardware, software, and/or firmware for supporting each of its respective functions. The components of autonomous site operator 202 included an AI framework 222, asset maintenance module 224, and process control module 226. AI framework 222 includes hardware, software, and/or firmware for applying artificial intelligence techniques to data stored in data store 210 and data received from asset maintenance module 224 and process control module 226, including establishing, training, and using at least one machine learning (ML) model, referred to as autonomous site model(s) 223 to perform diagnostics, make inferences, and/or evaluate inferences. AI framework 222 can further provide action signals, which can include recommendations, warnings, alarms, and/or control signals, such as to asset maintenance module 224 and/or process control module 226.

Autonomous site model(s) 223 are trained to perform AI tasks. Once trained, the autonomous site model(s) 223 can process information from data store 210 for performing the AI tasks for which they were trained. One or more of the autonomous site model(s) is trained to identify anomalies and/or diagnose the anomalies. In addition, the one or more of the autonomous site model(s) is trained to make inferences that can be used to identify which industrial equipment, which component of the industrial equipment, which aspect of the component should be inspected.

In addition, the one or more of the autonomous site model(s) is trained to make inferences that can be used to provide instructions for capturing the autonomous sensor data (e.g., routing and positioning an autonomous device 204, task instructions for which/how much data (e.g., image(s), measurement(s), etc.) to capture, how to capture the data (e.g., which sensors to use)), The instructions for capturing the autonomous sensor data can include selecting which autonomous device(s) 204 to use and can be customized for the selected autonomous device(s) 204.

In addition, the one or more of the autonomous site model(s) is trained to make inferences that can be used to identify a potential anomaly based on at least the captured autonomous sensor data. Examples of anomalies include, without limitation, a measurement or a change in a measurement that deviates from expected changes in view of conditions at the industrial site, environmental or ambient conditions that are out of an acceptable range, and evidence of degradation of the structure of a component of the industrial equipment in an image.

In addition, the one or more of the autonomous site model(s) is trained to make inferences that can be used to determine which actions should be taken to address the potential anomaly, including how to take that action. Addressing the potential anomaly can include, for example making an improvement or a change to avoid unwanted outcomes, such as inferior or inefficient operation, stoppage of operation, safety risks, unwanted waste output, inferior work product output, etc.

The autonomous device(s) 204 can include embedded AI that can include one or more machine learning autonomous device model(s) 205. Autonomous device model(s) 205 can be trained to perform AI tasks. The training can include local data and in some embodiments remote data. Once trained, the autonomous device model(s) 205 can process local data (and optionally some remote data) for performing the AI tasks for which they were trained. The AI tasks for which the autonomous device model(s) 205 are trained and perform can include some of the AI tasks described above with respect to the autonomous site model(s) 223, and can supplement and/or be simpler than the corresponding AI tasks performed by autonomous site model(s) 223 due to the reduced capacity of the embedded AI relative to the non-embedded AI used by autonomous site model(s) 223. More specifically, the autonomous device model(s) 205 can be limited to using local data or limited remote data (e.g., received via Bluetooth Low Energy™ (BLE™), near-field communication (NFC)).

The training processes used for training the autonomous site model(s) 223 and the autonomous device model(s) 205 can use supervised or unsupervised learning techniques and/or reinforcement learning techniques. An amount of training, such as determined by the amount and/or quality of training data used and/or embedded vs. non-embedded, and/or operator feedback can be used to determine an amount of confidence in the inferences made when using the autonomous site model(s) 223 and the autonomous device model(s) 205.

Asset maintenance module 224 includes hardware, software, and/or firmware for communicating with AI framework 222 and controllers of autonomous devices 204 (which can include operators for cases in which operators are involved in operation of autonomous devices 204). Asset maintenance module 224 can receive maintenance data from autonomous devices 204 or industrial site 206. The maintenance data can include live (meaning currently obtained, e.g., in real time) measurements from sensors in industrial site 206 or autonomous sensor data (or this can be received from data store 210), and can further include notifications of anomalies detected by autonomous devices 204 or the industrial equipment at industrial site 206. Maintenance data is typically data that is specific to the equipment and not to the process. Maintenance data can include, for example, data associated with vibration, heat, corrosion, leak detection. Maintenance data might also include hours of operation, which can be used to calculate service intervals. Asset maintenance module 224 can detect anomalies and/or forward notifications of detected anomalies or other maintenance context to AI framework 222.

Asset maintenance module 224 can receive from AI framework 222 action commands, recommendations, and or warnings for actions to be taken by autonomous devices 204 and/or operators, such as to perform a maintenance task or instruct the autonomous devices 204 to gather further autonomous sensor data. The maintenance task can include, for example, repair, replacement, or bypass of one or more specific components of industrial equipment industrial site 206. The warning may include a recommendation or command to disable a specific component. Asset maintenance module 224 can then send a control signal to perform the commanded action, activate an indicator (e.g., audio or visual indicator) to output a warning, or communicate the recommendation to a processor or operator. For example, operator approval may be required before a control signal issued by asset maintenance module 224 is allowed to cause the action. The recommendation can be for an operator to perform a task, such as to repair, replace, or shut down a specific component.

Process control module 226 includes hardware, software, and/or firmware for communicating with AI framework 222 and control system 212 (which can include operators for cases in which operators are involved in operation of control system 212). Process control module 226 can receive process data from industrial equipment of industrial site 206. The process context can include a measurement of material properties that are being transformed by the plant, for example measurements of flow, temperature, pH level, pressure, and/or related notifications of anomalies detected by processes of the industrial equipment. Process control module 226 can detect context associated with the process data and/or forward specific process data to AI framework 222.

Process control module 226 can receive from AI framework 222 process commands, recommendations, and or warnings for actions to be taken by the industrial equipment, control system 212, and/or operators, such as to change process parameters to control a process (e.g., to change process set points to increase or reduce characteristics such as flow rate, pressure, motor speed, pump speed), disable a process, and/or bypass a process (such as by opening or closing a valve or switch), divert a material or current (e.g., to a holding tank or battery, by opening or closing a valve or switch). Process control module 226 can then send a control signal to a process of the industrial equipment or to process system 212 to perform the commanded action, activate an indicator (e.g., audio or visual indicator) to output a warning, or communicate the recommendation to perform the commanded action. The recommendation can be provided to an operator, e.g., via an HMI of control system 212. For example, operator approval may be required before a control signal issued by process control module 226 is allowed to cause the action. The recommendation can be for the operator to perform a task, such as to disable or bypass a specific process.

Thus AI-based techniques are used to identify actual and potential issues that have arisen or are predicted to arise, and actions are taken to address the actual and/or potential issues.

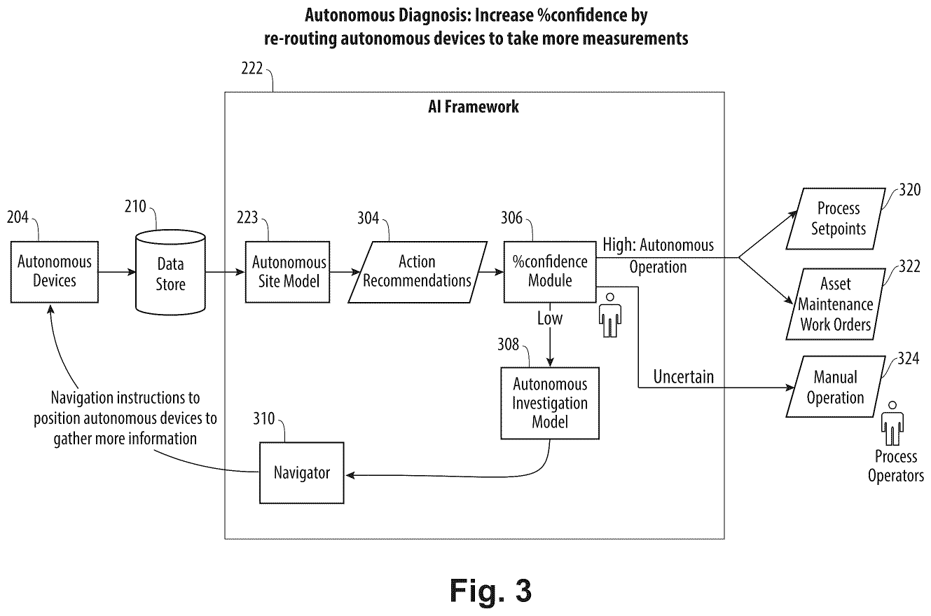

With reference now to FIGS. 3-6, shown are flow diagrams and flowcharts demonstrating implementation of the various exemplary embodiments. It is noted that the order of operations shown in FIGS. 3-6 is not required, so in principle, the various operations may be performed out of the illustrated order. Also, certain operations may be skipped, different operations may be added or substituted, some operations may be performed in parallel instead of strictly sequentially, or selected operations or groups of operations may be performed in a separate application following the embodiments described herein.

With reference to FIG. 3, a flow diagram is shown in which AI framework 222 performs an example method of processing autonomous sensor data and outputting action recommendations 304 or requesting further autonomous sensor data, depending on a confidence level (also referred to as % confidence) associated with the action recommendations 304.

Sensors of autonomous devices 204 provide autonomous sensor data to data store 210. AI framework 222 accesses or otherwise obtains data from data store 210, including the various types of data shown in FIG. 2A. Autonomous site model 223 processes the data from datastore 210 and outputs an action recommendation 304. The action recommendation can be a recommendation for a maintenance action or a process action.

The action recommendation 304 is further processed by % confidence module 306 to determine a confidence level in the action recommendation 304. The confidence module 306 can be included with or separate from autonomous site model 223. The confidence level can be determined based on operator feedback and/or an amount of training performed (e.g., the stage of the training process for training autonomous site model 223, an amount and/or quality of training data used, whether an operating scenario (e.g., a live or simulated combination of sensed conditions across industrial site 206, ambient or environmental conditions, and operator actions that were taken) that matches the current operating scenario being analyzed has previously occurred and a maintenance and/or process action has been performed with that operating scenario that resulted in an acceptable outcome).

In the example shown, the % confidence module can output a High, Low, or Uncertain score. If the output is High, an autonomous operation can be implemented in which the action recommended by action recommendation 304 is implemented with no or minimal human intervention. In one or more embodiments, approval by a human operator can be required before the action is actually implemented. When the action recommended includes a maintenance action, this can be provided, for example, as an asset maintenance work order. When the action recommended includes a process action, this can be provided as a signal to adjust process setpoints in the field of industrial site 206.

If the output is Uncertain, the action can be suppressed (e.g., blocked and not sent), can be sent as a recommendation that a human operator can implement, and/or as a recommendation requesting human operator feedback.

If the output is Low some pre-defined steps can be performed to improve the confidence level. In one example, the pre-defined steps include performing analysis by an autonomous investigation model 308 to identify which industrial equipment and/or their components should be investigated further and provide instructions for gathering additional autonomous sensor data in order to gain a more complete understanding of a detected anomaly and in order to provide a recommended action that has a high confidence level.

Navigator 310 generates navigation instructions for navigating one or more autonomous devices 304 to position their sensors to perform additional investigation of the industrial equipment identified by autonomous investigation model 308. The autonomous devices are thus instructed to follow the navigation instructions and instructions for gathering additional autonomous sensor data. The additional autonomous sensor data can be used by autonomous site model 223, such as for attempting again to generate an action recommendation 304 using the additional autonomous sensor data.

Autonomous investigation model 308 can be trained using ML techniques for performing AI tasks, similar to autonomous site model 223, to identify which industrial equipment and/or their components of industrial site 206 warrant further investigation. Autonomous investigation model 308 can be separate from or included with autonomous site model 223.

In certain scenarios, the navigation instructions can navigate an autonomous device 304 to a new location (e.g., industrial equipment suspected of (partially or fully) causing an anomaly) to gather new data that was not previously gathered. As more data is gathered using the inspection feedback loop controlled by autonomous further diagnosis model 308, the confidence level may rise to a high level, allowing autonomous implementation of a maintenance or process action. This autonomous process can avoid an occurrence of a fault or serious problem.

Operator feedback and/or performance feedback can be received for any of the above cases. The operator and/or performance feedback can be used by autonomous site model 223 for increasing or decreasing confidence for future similar operating scenarios. Additionally, for any of the above cases, an HMI display can be updated to show updated metrics, dashboards, confidence levels, decisions regarding implementation of actions. The HMI can be updated, for example, to demonstrate or simulate implementation of the work order or process setpoint adjustment.

In one or more embodiments, an example method of the disclosure includes determining a confidence level in identification of a potential anomaly or in identification of industrial equipment to be, wherein the at least one action taken depends on the confidence level.

In one or more embodiments, when the confidence level is below a threshold, the at least one action includes controlling the respective routes of the autonomous device(s) to obtain additional autonomous sensor data related to the anomaly. The example method can further include adjusting the confidence level in the detection of the anomaly as a function of the additional autonomous sensor data.

In one or more embodiments, when the confidence level is equal to or above a threshold, the at least one action includes a) controlling or recommending adjustment of a control parameter for controlling a process in the field and b) controlling or recommending application of a maintenance action to the industrial site.

In one or more embodiments, the method includes training, using machine learning, the autonomous site model 223 or the autonomous device model 205 to identify the equipment, process the autonomous sensor data, identify the potential anomaly, and determine the at least one action. The method includes setting the confidence level, wherein the confidence level as a function of an amount of training performed.

In one or more embodiments, the method includes training using machine learning at least one of the identifying the equipment, processing the autonomous sensor data, identifying the potential anomaly, and determining the at least one action, setting a confidence level in the recommended action, the confidence level being a function of an amount of the training performed, and in response to the confidence level being below a threshold, controlling the respective routes of the one or more autonomous mobile device to obtain additional autonomous sensor data related to the anomaly, wherein processing the additional autonomous sensor data increases the confidence level.

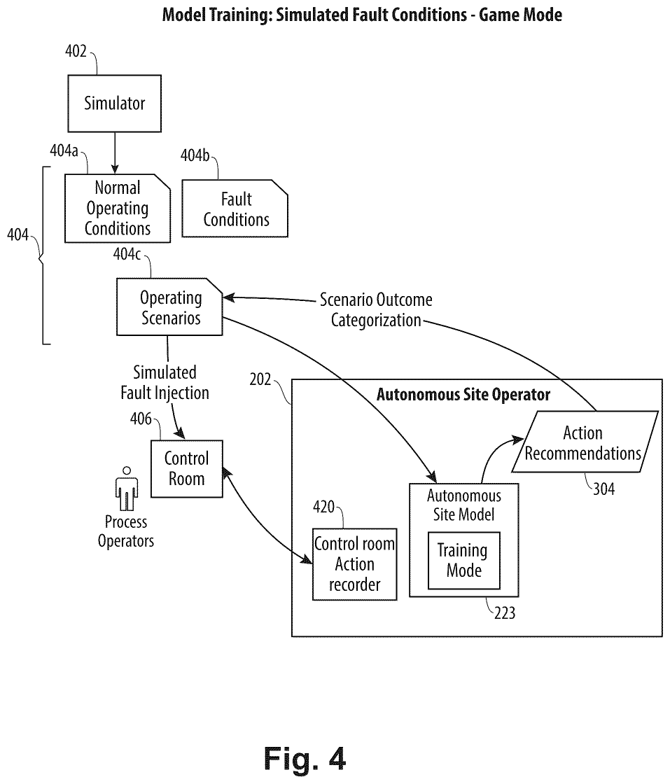

With reference to FIG. 4, a flow diagram is shown in which autonomous site operator 202 and a simulator 402 perform an example method of training autonomous site model 223 using simulation data 404, including normal conditions 404a, fault conditions 404b, and operating conditions 404c. The simulation data 404, including fault conditions, is injected into a control room 406 operated by process operators. Operation of autonomous site operator 202 and control room 406 with the injected fault conditions is also referred to as game mode.

Autonomous site operator 202 includes a control room action recorder 420 that records operator actions performed in control room 406. In one or more embodiments, control room action recorder 420 can autonomously implement operator actions in control room 406. Autonomous site operator 202 generates an inference outcome as action recommendations 304, wherein the inferences are based on the simulated input.

An example use case of the illustrated game mode includes initially, during a first training stage, training autonomous site operator 202 using operator actions recorded by control room action recorder 420 during unstimulated actual operation of industrial site 106 using control room 406. During the first training stage, the operator operates manually, without receiving suggested maintenance or process actions from autonomous site operator 202. This first training stage can be performed using simulations the different combinations (one simulation per combination) of various operating scenarios with normal, current operating conditions 404a or various fault conditions 404b. Each simulation can be reset at the beginning of the simulation to use existing, current operating of industrial site 106. Simulator 402 operates as a digital twin and simulates how industrial site 206 would react to the simulated combinations. Resulting operating scenarios are processed by autonomous site model 223, such as to assess maintenance of safety and operation productivity.

During a second training stage, autonomous site operator 202 is trained using hundreds of simulations of different combinations of operating scenarios 404c with normal conditions and with or without the various fault conditions 404b. As in the first training stage, each simulation can be reset at the beginning of the simulation to use existing, current operating of industrial site 106. Simulator 402 operates as a digital twin and simulates how industrial site 206 would react to the simulated combinations. For each simulation, operator actions are performed by implementing action recommendations 304. The operator actions are recorded by control room action recorder 420 and processed by simulator 402. Resulting operating scenarios are processed by autonomous site model 223, such as to assess maintenance of safety and operation productivity.

The assessed operating scenarios from the first and training stages are categorised as being good or bad outcomes. Good outcomes resulting from specific action recommendations are used to re-enforce the action recommendations within the training data and build confidence levels associated with the corresponding action recommendations for the operating conditions and operating scenarios.

In a third training stage, to increase the training data set, autonomous site model 202, while still operating in the simulated environment, is configured to infer operating actions, bypassing the human operator and simulating the recommended actions. Thus, the training can continue autonomously.

By simulating fault conditions, recommendations for actions responsive to such fault conditions and out-of-range conditions can be assessed and categorized, including for fault conditions that rarely occur and for which it would otherwise be difficult to obtain training data. An algorithm that is only trained on the narrow range of settings that a control system normally works within will not be able to infer recommendations for out-of-range behaviours.

In one or more embodiments, an example method of training the autonomous site model 223 includes injecting an anomalous simulated scenario into a simulation of the industrial site, such as a selected operating scenario with one or more fault conditions. The method can further include monitoring operator actions responsive to the anomalous scenario and monitoring respective outcomes of the operator actions, such as how the simulated operating conditions of the industrial site 206 are affected. The method can further include correlating the anomalous scenario, operator actions, and respective outcomes for future inferences.

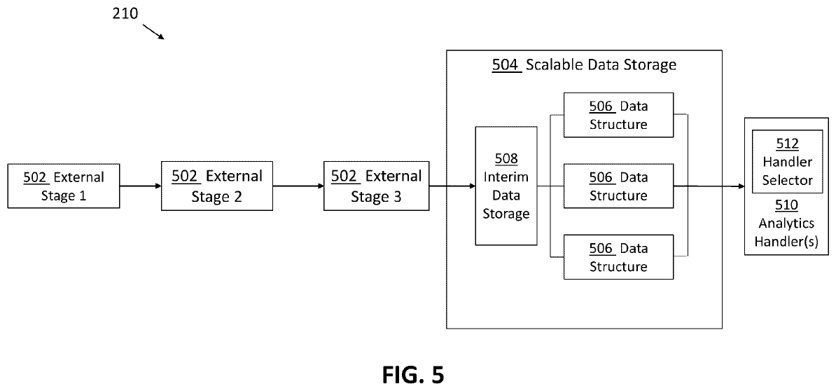

With reference to FIG. 5, a data pipeline of data store 210 is shown having several external stages 502 for collecting data, wherein the data is collected from a source (e.g., as shown in FIG. 2A) and moved through the external stages 502 to a scaled data storage 504 in condition and accessible for analytics and machine learning, after which the data can be viewed using one or more analytics handlers 510 for analyzing and/or visualizing results of the analysis.

Some options for external stages 502 include a relational database (RDB), an enterprise data base (EDB), a transactional database, and a customer relationship management (CRM) solution. In an example, a solution for a first of the external stages 502 is an RDB that is optimized for fast writes and responses (e.g., Amazon® Aurora® or the like). The data from the first and other early external stages can be moved to a cloud-based object storage service, such as Amazon S3®, e.g., via a data transfer or data migration service (e.g., AWS DMS®, DMC™, Amazon AppFlow®).

Thus, FIG. 5 illustrates an example of moving data from one or more legacy system, isolated data sources, and/or domains. It is noted that one or more first external stages 502 and feed into a second external stage 502, one or more second external stages 502 can feed into a third external stage 502, and one or more third external stages 502 can feed into a holding area 508 and analytics handler 510. This master data management allows data ingestion points, ERP, CRM, and field data to be combined into a single trustworthy source that is available for analytics. Once the data is managed into the single source, the analytics and AI framework 222 can be built on top of that.

Some examples of scaled data storage 504 include one or more data lakes or data warehouses 504. The scaled data storage 504 is suitable to handle scaling of data sets and support analytical queries. Separating storage, compute, and system services enables decoupling as respective resources can be scaled dynamically based on the respective application workloads without disruption, thus delivering full elasticity across these dimensions. One example scaled data storage 504 is Snowflake®.

In an example method, once data is stored in a final external stage 502, the data can be extracted and can further be converted and formatted, e.g., to a predetermined data type and a predetermined format. In this way, the data that has been collected and moved through the external stages 502 can be collected from various types of sources that use different types and formats.

In certain embodiments, the data can then be moved to an interim storage area 508 of the scaled data storage 504, where the data is temporarily held in holding processed before being moved to its final destination. The data can then be moved to its final destination within the scaled data storage 504, such as a data structure 506, e.g., a table, a Snowflake table, etc. The final destination can be updated, e.g., as additional data is captured and moved to the scalable data storage 504 and can be highly accessible for performance of analytics and machine learning. In certain embodiments, the scaled data storage 504 is not structured. Features of scaled data storage 504, can include the ability to ingest data from any source (e.g., ERP, CRM, product ecosystem), the ability to identify unexpected correlations, the ability to immediately access the stored data, the ability to extract, transform, and load (ETL) the data, and the ability to store the data in a state ready for analytics and/or machine learning.

Analytics handlers 510 can be an analytics database designed to handle an extensive workload, such is required for machine learning tools that is compatible and flexible for usage with scalable data storage 504 in an efficient manner, and is agnostic to sources of the data. Analytics handlers 510 can be configured to perform analytics and/or visualize results of the analytics. Some example analytics handlers 510 can include ElastiCube® and/or Live Models®.

Analytics handler(s) can interface with and provide data to AI framework 222 and autonomous site model 223. The analytics and/or visualizations performed can be responsive to user queries, e.g., via a dashboard provided by a user interface, such as an HMI of a control room.

In one or more embodiments, analytics handler(s) 510 include a handler selector 512 for determining which analytics handler 510 of multiple analytics handler 510 to use and/or when to submit a query. Since the different analytic handlers 510 may interact differently with scalable data storage, queries can be handled more quickly and/or with less processing costs (e.g., speed and resource utilization) depending on which analytic handler 510 is selected. The determination of which analytics handler 510 to use can be made based on factors such as a frequency of queries received (e.g., via the HMI) or submitted to scalable data store 504 within a particular time period, refresh times (an amount of time needed to refresh the stored data to be ready for read and write accesses), whether the queries are being handled on demand or in batches, amount of data stored in data structures 506 or unstructured data stores of scalable data store 504, and how the individual analytic handlers 510 and scalable data storage 504 are configured to function (e.g., whether refreshes are used by the analytic handler). The determination of which analytics handler 510 to use can be dynamic, such as based on the current rate of queries processed or amount of data stored. It is noted that the analytics handler 510 can be configured so that its stored data is refreshed separately and independently from data stored by scalable data store 504. A different analytics handler 510 may not require or use refreshing of its stored data that is separate or independent from scalable data storage 504.

For example, when the volume of queries to be processed in a given time period is high, scalable data storage 504 may consume greater resources. A first analytics handlers 510 may be configured to only query the scalable data store 504 when there is a need to refresh data tables of the first analytics handler 510, as opposed to each time a query is received via the dashboard, which may reduce a processing burden. However, refresh times for refreshing data structures 506 of scalable data store 506 can depend on a size of the data structures 506 being refreshed, slowing the query response time when data structures 506 hold large amounts of data.

A second analytics handler 510 that is connected directly to scalable data store 504 may use less or different processing resources. Selection of which analytics handler 510 can depend on which processing resources would be used, as well as the processing resources' capacity and speed and the query response time needed.

An example method of using the data pipeline shown in FIG. 5 includes, locally storing batches of data of live measurement and/or control data from the industrial equipment, the historical measurement and/or control data from the industrial equipment, the autonomous sensor data, the extrinsic data, and the supervisory data, e.g., using one or more of external stages 502. In one or more embodiments, storing the data locally can use a transactional database.

The example method can further include processing the batches of data, for uniformity and/or normalization before and/or after storing the batches of data locally, and storing the processed batches of data in large data sets in a data warehouse and/or data lake. The analyzing is performed on the large data sets.

In one or more embodiments, an example method of using the data pipeline shown in FIG. 5 can include comparing frequency of queries, refresh times of stored data, and/or size of data structures used for storing the data in the data lake or data warehouse. The example method further includes selecting, based on a result of the comparison, a method of handling the analysis, e.g., for applying machine learning to make inferences or visualizing a result of the machine learning.

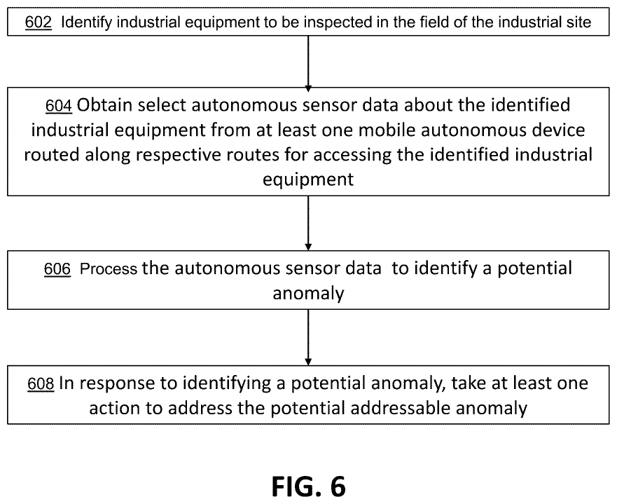

With reference to FIG. 6, a flowchart of an example method is shown that can be performed by autonomous site operator 202 and/or autonomous devices 204, separately or together. At block 602, industrial equipment is identified to be inspected in the field of the industrial site, At block 604, select autonomous sensor data is obtained about the identified industrial equipment from at least one mobile autonomous device routed along respective routes for accessing the identified industrial equipment. At block 606, the autonomous sensor data is processed to identify a potential anomaly. At block 608, in response to identifying a potential anomaly, at least one action is taken to address the potential addressable anomaly.

In one or more embodiments, the method can further include receiving live measurement and/or control data from the industrial equipment, wherein as a combination, identifying the equipment, processing the autonomous sensor data, identifying the potential anomaly, and determining the at least one action uses the live measurement and/or control data.

In one or more embodiments, the extrinsic data includes at least one of user profile of an operator performing control operations on the industrial site, governance information pertaining to the industrial site, and the at least one action customizes information for display to the operator based on the user profile and the industrial site.

In one or more embodiments, the method can further include capturing the select autonomous sensor data.

In one or more embodiments, the method can further include wherein the at least one autonomous device 204 can be trained to identify the select autonomous data to be captured. For example, the at least one autonomous device 204 can use trained embedded AI capabilities to make inferences based on stored and locally obtained data, or remote data obtained using NFC. For example, the autonomous device 204 may have been navigated by anomalous site model 223 to a particular industrial equipment to investigate it further for an anomaly. The autonomous device 204 may use its embedded AI or look up in its stored data information data about the industrial equipment to which it was navigated. It may identify the industrial equipment upon arrival, such as by determining it is a certain model (e.g., by reading an optical code tag). It may use its knowledge about the industrial equipment (stored or newly discovered) to determine what features of the industrial equipment should be measured or imaged.

In one or more embodiments, processing the autonomous sensor data is performed by the mobile autonomous device. The autonomous sensor data can perform a portion or all of processing autonomous sensor data it obtained. For example, it may process image data that it captured and determine that a crack is visible.

In one or more embodiments, the mobile autonomous device can process the autonomous sensor data and takes an action of the at least one action responsive to identification of the potential anomaly. For example, processing locally obtained data or data obtained using NFC and applying embedded AI, the autonomous device can determine that a defect or phenomenon should be investigated further, and selects an action to do so, such as to determine the full extent of a crack or corrosion, to seek a source of smoke, upon sensing a temperature that is above normal range determining where the highest temperature can be found.

In one or more embodiments, the action selected and taken by the autonomous device can include generating an alarm, capturing additional select autonomous sensor data, and/or adjusting its route, such as to investigate an adjacent industrial equipment that may be affected or involved in the identified anomaly.

In one or more embodiments, the select autonomous sensor data includes processed image data to detect a defect or a phenomenon (a crack, the presence of smoke, etc.), read analog information from an analog measurement device (e.g., an analogue gauge or level), determine a position of an actuator device (e.g., a lever) included with the industrial equipment and/or a component of the industrial site acted upon by the actuator device.

In one or more embodiments, the select autonomous sensor data includes any of sensed temperature, pressure, radiation, a particular chemical, and motion.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart(s) and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

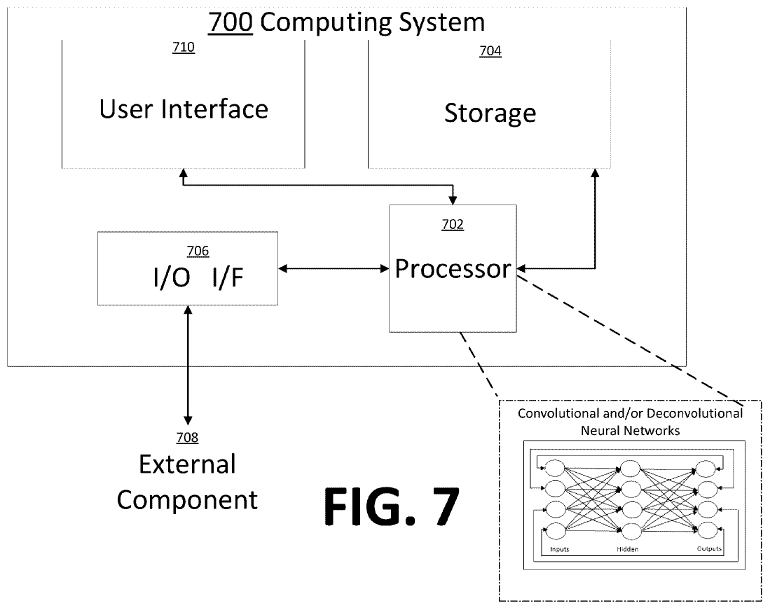

With reference to FIG. 7, a block diagram of an example computing system 700 is shown, which provides an example configuration of computing components used in autonomous site operator 202 and autonomous devices 204. Additionally, all or portions of the computing components could be configured as software, and computing system 700 could represent such portions. Computing system 700 is only one example of a suitable system and is not intended to suggest any limitation as to the scope of use or functionality of embodiments of the disclosure described herein. Computing system 700 can be implemented using hardware, software, and/or firmware. Regardless, computing system 700 is capable of being implemented and/or performing functionality as set forth in the disclosure.

Computing system 700 is shown in the form of a general-purpose computing device. Computing system 700 includes a processing device 702, memory 704, an input/output (I/O) interface (I/F) 706 that can communicate with an internal component, such as a user interface 710, and optionally an external component 708. Processing device 702 can further include or access neural networks, which can include convolutional and/or deconvolutional neural networks.

The processing device 702 can include, for example, a PLOD, microprocessor, DSP, a microcontroller, an FPGA, an ASCI, and/or other discrete or integrated logic circuitry having similar processing capabilities.

The processing device 702 and the memory 704 can be included in components provided in the FPGA, ASCI, microcontroller, or microprocessor, for example. Memory 704 can include, for example, volatile and non-volatile memory for storing data temporarily or long term, and for storing programmable instructions executable by the processing device 702. Memory 704 can be a removable (e.g., portable) memory for storage of program instructions. I/O I/F 706 can include an interface and/or conductors to couple to the one or more internal components 710 and/or external components 708.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the block diagram block or blocks.

Embodiments of the computing components may be implemented or executed by one or more computer systems, such as a microprocessor. Each computer system 700 can be included within the computing components, or multiple instances thereof. In the example shown, computer system is embedded in the computing components. In various embodiments, computer system 700 may include one or more of a microprocessor, an FPGA, application specific integrated circuit (ASCI), microcontroller. The computer system 700 can be provided as an embedded device. Portions of the computer system 600 can be provided externally, such by way of a centralized computer, a data concentrator, a cockpit computing device controls display of gap status, e.g., notifications about the gap or alerts, or the like.

Computer system 700 is only one example of a suitable system and is not intended to suggest any limitation as to the scope of use or functionality of embodiments of the disclosure described herein. Regardless, computer system 700 is capable of being implemented and/or performing any of the functionality set forth hereinabove.

Computer system 700 may be described in the general context of computer system-executable instructions, such as program modules, being executed by a computer system. Generally, program modules may include routines, programs, objects, components, logic, data structures, and so on that perform particular tasks or implement particular abstract data types.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be appreciated that the concepts, systems, circuits and techniques sought to be protected herein are not limited to use in the example applications described herein (e.g., industrial applications), but rather may be useful in substantially any application where it is desired to enable and improve autonomous industrial operation and repair. While particular embodiments and applications of the present disclosure have been illustrated and described, it is to be understood that embodiments of the disclosure not limited to the precise construction and compositions disclosed herein and that various modifications, changes, and variations can be apparent from the foregoing descriptions without departing from the spirit and scope of the disclosure as defined in the appended claims.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

Accordingly, it is submitted that that scope of the patent should not be limited to the described embodiments but rather should be limited only by the spirit and scope of the following claims.

What is claimed is:

1. A method of autonomous anomaly management of an industrial site having industrial equipment in the field of the industrial site, the method comprising:
identifying industrial equipment to be inspected in the field of the industrial site;
obtaining select autonomous sensor data about the identified industrial equipment from at least one mobile autonomous device routed along respective routes for accessing the identified industrial equipment;
processing the autonomous sensor data to identify a potential anomaly; and
in response to identifying a potential anomaly, taking at least one action to address the potential anomaly,
wherein, as a combination, identifying the equipment, processing the autonomous sensor data, identifying the potential anomaly, and determining the at least one action use historical measurement and/or control data from the industrial equipment, historical autonomous sensor data, extrinsic data including enterprise data, customer relationship management data, guidance data, optimization data, and/or constraint data about the industrial site, and supervisory and control data generated and/or collected by supervisory control of the industrial site disposed remote from the field.

2. The method of claim 1, further comprising receiving live measurement and/or control data from the industrial equipment, wherein as a combination, identifying the equipment, processing the autonomous sensor data, identifying the potential anomaly, and determining the at least one action uses the live measurement and/or control data.

3. The method of claim 1, further comprising determining a confidence level in identification of the potential anomaly or in identification of industrial equipment to be inspected in view of the identified potential anomaly, wherein the at least one action taken depends on the confidence level.

4. The method of claim 3, wherein when the confidence level is below a threshold, the at least one action includes controlling the respective routes of the one or more autonomous mobile device to obtain additional autonomous sensor data related to the anomaly, the method further comprising adjusting the confidence level in the detection of the anomaly as a function of the additional autonomous sensor data.

5. The method of claim 3, wherein when the confidence level is equal to or above a threshold, the at least one action includes a) controlling or recommending adjustment of a control parameter for controlling a process in the field and b) controlling or recommending application of a maintenance action to the industrial site.

6. The method of claim 1, wherein the method further comprises:
training using machine learning the at least one of the identifying the equipment, processing the autonomous sensor data, identifying the potential anomaly, and determining the at least one action; and
setting a confidence level as a function of an amount of the training performed.

7. The method of claim 1, wherein the training includes:
injecting an anomalous scenario into a simulation of the industrial site;
monitoring operator actions responsive to the anomalous scenario;
monitoring respective outcomes of the operator actions; and
correlating the anomalous scenario, operator actions, and respective outcomes for future inferences.

8. The method of claim 1, further comprising:
locally storing batches of data of live measurement and/or control data from the industrial equipment, the historical measurement and/or control data from the industrial equipment, the autonomous sensor data, the extrinsic data, and the supervisory data;
processing the batches of data, for uniformity and/or normalization before and/or after storing the batches of data locally; and
storing the processed batches of data in a large data set in a data warehouse and/or data lake,
wherein the analyzing is performed on the large data set.

9. The method of claim 8, wherein storing the batches of data locally uses a transactional database.

10. The method of claim 8, wherein storing the processed batches of data in the large data sets uses dynamically scaled compute resources and separated data structures that are separately refreshable.

11. The method of claim 8, comprising:
comparing frequency of queries, refresh times of stored data, and/or size of data structures used for storing the data in the data lake or data warehouse; and
selecting a method of handling the analysis based on a result of the comparison.

12. The method of claim 1, wherein the extrinsic data includes at least one of user profile of an operator performing control operations on the industrial site, governance information pertaining to the industrial site, and the at least one action customizes information for display to the operator based on the user profile and the industrial site.

13. The method of claim 1, further comprising capturing the select autonomous sensor data.

14. The method of claim 13, wherein the at least one autonomous device is trained to identify the select autonomous data to be captured.

15. The method of claim 1, wherein processing the autonomous sensor data is performed by the mobile autonomous device.

16. The method of claim 13, wherein the select autonomous sensor data includes processed image data to detect a defect or a phenomenon, read analog information from an analog measurement device, determine a position of an actuator device included with the industrial equipment and/or a component of the industrial site acted upon by the actuator device.

17. The method of claim 13, wherein the select autonomous sensor data includes any of sensed temperature, pressure, radiation, a particular chemical, and motion.

18. The method of claim 13, wherein the mobile autonomous device processes the autonomous sensor data and takes an action of the at least one action responsive to identification of the potential anomaly.

19. The method of claim 18, wherein the action includes generating an alarm, capturing additional select autonomous sensor data, and/or adjusting its route.

20. A system for performing autonomous inspections of equipment and/or processes in an industrial plant, comprising:
a memory configured to store a plurality of programmable instructions; and
a processing device in communication with the memory, wherein the processing device, upon execution of the plurality of programmable instructions is configured to:
identify industrial equipment to be inspected in the field of the industrial site;
obtain select autonomous sensor data about the identified industrial equipment from at least one mobile autonomous device routed along respective routes for accessing the identified industrial equipment;
process the autonomous sensor data to identify a potential anomaly; and
in response to identifying a potential anomaly, take at least one action to address the potential anomaly,
wherein, as a combination, identifying the equipment, processing the autonomous sensor data, identifying the potential anomaly, and determining the at least one action use historical measurement and/or control data from the industrial equipment, historical autonomous sensor data, extrinsic data including enterprise data, customer relationship management data, guidance data, optimization data, and/or constraint data about the industrial site, and supervisory and control data generated and/or collected by supervisory control of the industrial site disposed remote from the field.

21. A method of autonomous anomaly management of an industrial site having industrial equipment in the field of the industrial site, the method comprising:
identifying industrial equipment to be inspected in the field of the industrial site;
obtaining select autonomous sensor data about the identified industrial equipment from at least one mobile autonomous device routed along respective routes for accessing the identified industrial equipment;
processing the autonomous sensor data to identify a potential anomaly;
in response to identifying a potential anomaly, recommending at least one action to address the potential anomaly;
training using machine learning at least one of the identifying the equipment, processing the autonomous sensor data, identifying the potential anomaly, and determining the at least one action;
setting a confidence level in the recommended action, the confidence level being a function of an amount of the training performed; and
in response to the confidence level being below a threshold, controlling the respective routes of the one or more autonomous mobile device to obtain additional autonomous sensor data related to the anomaly, wherein processing the additional autonomous sensor data increases the confidence level.

22. The method of claim 1, further comprising receiving dynamic autonomous device status data about individual and/or fleets of autonomous devices, wherein the autonomous device status data is used for selecting one or more autonomous devices to perform the at least one action.
